(19) United States
(12) Patent Application Publication
(10) Pub. No.: US 2026/0042081 A1
(43) Pub. Date: Feb. 12, 2026

(54) MICROPOROUS STRUCTURED SORBENTS

(71) Applicant: Saudi Arabian Oil Company, Dhahran (SA)

(72) Inventors: Junyan Yang, Acton, MA (US); Brian Hanna, West Roxbury, MA (US); Wajdi Al-Sadat, Cambridge, MA (US); Michael Forte, Cambridge, MA (US); Douglas Theberge, Gardner, MA (US); Mourad Younes, Dhahran (SA); Ammar Al-Ahmed, Dhahran (SA); Dana A. Wong, Cambridge, MA (US)

(21) Appl. No.: 18/797,616

(22) Filed: Aug. 8, 2024

(51) Int. Cl. B01J 20/22; B01D 53/047; B01J 20/28; B01J 20/30; B01J 20/32; B01J 20/34

(52) U.S. Cl. CPC B01J 20/226; B01D 53/0476; B01J 20/2803; B01J 20/3042; B01J 20/3204; B01J 20/3244; B01J 20/3466; B01J 20/3483; B01D 2253/204; B01D 2257/504; B01D 2258/0283; B01D 2259/4009

(57) ABSTRACT

Structured sorbents including a metal organic framework, hydrophobic binder, and hydrophobic carrier, wherein the hydrophobic carrier includes fluorinated silica. Methods of making structured sorbents and using structured sorbents in direct air capture of CO₂.

### TECHNICAL FIELD

This document relates to structured sorbents for CO₂ capture and methods of making structured sorbents.

### BACKGROUND

The extraction of CO₂ directly from atmospheric air, known as direct air capture (DAC), has received increasing attention as an essential net-zero emission technology due to its scalability potential and certifiability. Metal-organic frameworks (MOF) are used for their CO₂ capture abilities. Metal-organic frameworks include intricate three-dimensional structures including metal ions or clusters linked by organic ligands. MOFs boast high CO₂ capacity attributed to their high surface functionality and porosity, alongside remarkable tunability. However, research indicates that MOFs utilized for CO₂ capture face stability issues, practically concerning hydrolytic stability in humid environments, leading to elevated H₂O co-adsorption capacity and moisture-induced degradation, constraining their practical applicability.

### SUMMARY

This disclosure describes superhydrophobic structured composite sorbents.

In some embodiments, a structured sorbent includes a metal organic framework, a hydrophobic binder, and a hydrophobic carrier including fluorinated silica.

In some embodiments, a method of making a structured sorbent includes preparing a binder solution, wherein the binder solution includes a hydrophobic polymer and a first organic solvent, preparing a hydrophobic carrier suspension, wherein the hydrophobic carrier suspension includes fluorinated silica and a second organic solvent, mixing the binder solution and the hydrophobic carrier suspension to form a slurry, adding a metal organic framework to the slurry to form a dope solution, and adding the dope solution to a quench bath to precipitate the structured sorbent.

In some embodiments, a method of capturing CO₂ includes contacting a structured sorbent with a CO₂ containing feed stream to yield a CO₂ depleted stream and a CO₂-loaded structured sorbent, wherein the structured sorbent includes a metal organic framework, a hydrophobic binder, and a hydrophobic carrier, wherein the hydrophobic carrier includes fluorinated silica, hydraulically isolating the CO₂-loaded structured sorbent from the feed stream, and recovering CO₂ from the CO₂-loaded structured sorbent to regenerate the structured sorbent.

The details of one or more implementations of the disclosure are set forth in the accompanying drawings and the description that follows. Other features, objects, and advantages of the disclosure will be apparent from the description and drawings, and from the claims.

### DESCRIPTION OF DRAWINGS

FIG. 1 shows the chemical structure of NbOF₅-Ni MOF.

FIG. 2 shows an example photograph of NbOF₅-Ni MOF powder.

FIG. 3 shows example fluorinated silica compositions.

FIG. 4 shows a schematic of an example phase inversion process.

FIG. 5 is a photograph of example PVDF/NbOF₅-Ni MOF/F-SiO₂ beads precipitated from a phase inversion process.

FIG. 6 is a flowchart of an example method of making a structured sorbent.

FIG. 7 is a flowchart of an example method of capturing carbon.

FIG. 8A shows an example schematic of direct air capture of CO₂ using structured sorbents.

FIG. 8B is a flowchart of an example embodiment of direct air capture.

FIG. 9 is a photograph of example PVDF/NbOF₅-Ni MOF/F-SiO₂ beads (20/70/5 wt %) produced via a phase inversion process.

FIG. 10 is a photograph of example PVDF/NbOF₅-Ni MOF (10/90 wt %) beads produced via a phase inversion process.

FIG. 11 is a photograph of example PMMA/NbOF₅-Ni MOF cubes.

FIG. 12 is an SEM image of example PMMA/NbOF₅-Ni MOF cube sorbents formed through a templated drying process.

FIG. 13A is an SEM image of PVDF/NbOF₅-Ni MOF beads synthesized using a phase inversion process.

FIG. 13B is an SEM image of PVDF/NbOF₅-Ni MOF beads synthesized using a phase inversion process.

FIG. 14A is an SEM images of PVDF/NbOF₅-Ni MOF/F-SiO₂ beads synthesized via a phase inversion process.

FIG. 14B is an SEM images of PVDF/NbOF₅-Ni MOF/F-SiO₂ beads synthesized via a phase inversion process.

FIG. 15A shows an example water drop test on a PVDF/NbOF₅-Ni MOF flat membrane.

FIG. 15B shows an example water drop test on a PVDF/NbOF₅-Ni MOF/F-SiO₂ flat membrane.

FIG. 16 shows example TGA curves of NbBOFs-Ni MOF powder compared to a PMMA/NbOF₅-Ni MOF sorbent and a PVDF/NbOF₅-Ni MOF sorbent.

FIG. 17 shows the results of a CO₂ sorption study of PMMA/NbOF₅-Ni MOF (10/90 w/w) sorbent and PVDF/NbOF₅-Ni MOF (10/90 w/w) sorbent.

FIG. 18 shows a comparison of CO₂ cyclic sorption for the templated PMMA/NbOF₅-Ni MOF cubes and the phase inversion synthesized PVDF/NbOF₅-Ni MOF beads and PVDF/NbOF₅-Ni MOF/F-SiO₂ beads.

FIG. 19 shows a comparison of CO₂ and H₂O adsorption during an adsorption column breakthrough experiment under humid conditions.

FIG. 20A shows example adsorption breakthrough curves for microporous PVDF/NbOF₅-Ni MOF/F-SiO₂ composite beads.

FIG. 20B is a photograph of the starting material and steamed material of PVD/NbOF₅-Ni MOF beads used in an exemplary embodiment.

FIG. 20A shows adsorption breakthrough curves for example templated PMMA/NbOF₅-Ni MOF cubes.

FIG. 21B is a photograph of the starting material and steamed material (i.e., post adsorption study) of PMMA/NbOF₅-Ni MOF cubes from an exemplary embodiment. Like reference symbols in the various drawings indicate like elements.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Provided in this disclosure, in part, are structured sorbents and methods of making structured sorbents. As used herein, the term “structured sorbents” refers to powder or synthesized sorbents that are morphed into workable geometries, such as extrudates, pellets, 3D printed shapes, or coated on surfaces. This disclosure describes structured sorbents which are discrete units or pellets with a macroscopic 3-dimensional shape, rather than sorbents which are substantially an unshaped powder. The structured sorbent units or pellets are on the order of 1 mm to 10 mm in diameter, for example 1 mm-9 mm, 1 mm-8 mm, 1 mm-7 mm, 1 mm-6 mm, 1 mm-5 mm, 1 mm-4 mm, 1 mm-3 mm, 1 mm-2 mm, 2 mm-10 mm, 3 mm-10 mm, 4 mm-10 mm, 5 mm-10 mm, 6 mm-10 mm, 7 mm-10 mm, 8 mm-10 mm, or 9 mm-10 mm in diameter. In some embodiments, the structured sorbent units or pellets are 1 mm, 2 mm, 3 mm, 4 mm, 5 mm, 6 mm, 7 mm, 8 mm, 9 mm, or 10 mm in diameter.

Solid sorbents employ chemisorption, physisorption or a combination thereof to capture or separate CO₂ from a feed stream. Conventional solid sorbents, such as porous carbons, zeolites, mesoporous silicas, aminated polymers, and polyethyleneimine-impregnated resin, have been explored for CO₂ capture. However, these sorbents are hindered by low CO₂ capacity at an ultralow concentration of about 400 ppm CO₂ or stability or degradation issues in the presence of oxygen. In contrast, metal organic frameworks (MOFs) exhibit high CO₂ capacity, attributed to their high surface functionality and porosity, as well as remarkable tunability. However, MOFs utilized for CO₂ capture face hydrolytic stability in humid environments, leading to elevated H₂O co-adsorption capacity and moisture-induced degradation. As described herein, the inclusion of a binder and a hydrophobic carrier can improve the properties of MOFs utilized for CO₂ capture as compared to MOFs that do not include the binder and hydrophobic carrier.

The structured sorbents described herein include a MOF, a binder, and a hydrophobic carrier. Doping hydrophobic carriers into the sorbent via, for example, a phase inversion process is a simple but effective shaping technique that can reduce humidity sensitivity of the resulting product, enabling it to better adapt to complex environmental conditions. Further, the structured sorbents as described herein are suitable for industrial scale applications, with desirable adsorption properties and advanced geometric configuration, compared to unshaped powders. Unshaped powders in an industrial application cause a large gas pressure drop. In some embodiments, shaping MOFs on a macroscopic level from a fine microcrystalline powder into a shaped body yields structured sorbents suitable for industrial applications. Further, shaping the sorbents, such as the structured sorbents of the present disclosure, for off-gas processes improves handling and reduces the pressure drop for flow-through systems. In addition, structured sorbents produced with a phase inversion process with microporous structures, such as described in the present disclosure, can achieve rapid CO₂ mass transfer and high working capacities.

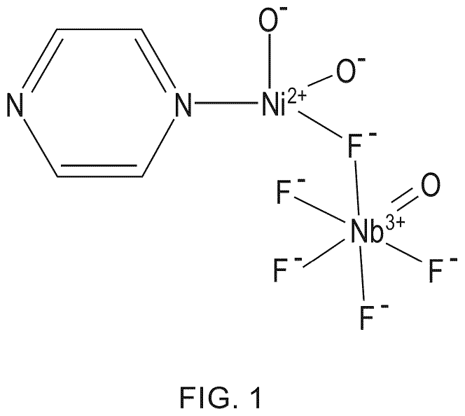

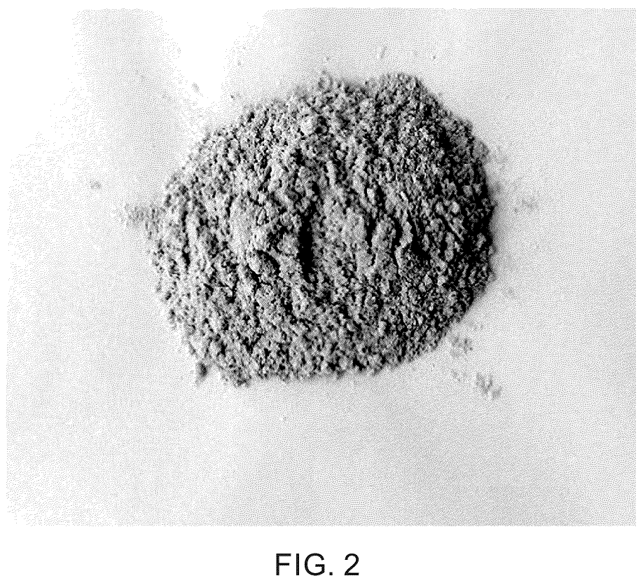

As described herein, the structured sorbents include a MOF, a binder, and a hydrophobic carrier. In some embodiments, the MOF is NbOF₅-Ni MOF. FIG. 1 shows the chemical structure of NbOF₅-Ni MOF. FIG. 2 shows an example photograph of NbOF₅-Ni MOF powder. In some embodiments, the solid sorbent is 50-95% NbOF₅-Ni MOF by weight. For example, the solid sorbent can include from about 55 to about 95 wt %, from about 60 to about 95 wt %, from about 65 to about 95 wt %, from about 70 to about 95 wt %, from about 75 to about 95 wt %, from about 80 to about 95 wt %, from about 85 to about 95 wt %, from about 90 to about 95 wt %, from about 50 to about 90 wt %, from about 50 to about 85 wt %, from about 50 to about 80 wt %, from about 50 to about 75 wt %, from about 50 to about 70 wt %, from about 50 to about 65 wt %, from about 50 to about 60 wt %, from about 50 to about 55 wt %, about 50 wt %, about 55 wt %, about 60 wt %, about 65 wt %, about 70 wt %, about 75 wt %, about 80 wt %, about 85 wt %, about 90 wt %, or about 95 wt % NbOF₅-Ni MOF.

In some embodiments, the binder is a hydrophobic polymer. The hydrophobic polymer can include polystyrene-block-polybutadiene-block-polystyrene (SBS), polyvinylidene difluoride (PVDF), polyacrylonitrile (PAN), or any combination thereof. In some embodiments, the binder is PVDF. PVDF has a molecular weight of 250k to 670k. In some embodiments, PVDF improves the mechanical strength of the structured sorbent. In some embodiments, the hydrophobic polymer is incorporated into the structured sorbents from between 1 wt % to 50 wt %. For example, the structured sorbent can include from about 1 wt % to about 45 wt %, from about 1 wt % to about 40 wt %, from about 1 wt % to about 35 wt %, from about 1 wt % to about 30 wt %, from about 1 wt % to about 25 wt %, from about 1 wt % to about 20 wt %, from about 1 wt % to about 15 wt %, from about 1 wt % to about 10 wt %, or from about 1 wt % to about 5 wt % hydrophobic polymer. In some embodiments, the structured sorbent includes from about 5 wt % to about 50 wt %, from about 10 wt % to about 50 wt %, from about 15 wt % to about 50 wt %, from about 20 wt % to about 50 wt %, from about 25 wt % to about 50 wt %, from about 30 wt % to about 50 wt %, from about 35 wt % to about 50 wt %, from about 40 wt % to about 50 wt %, or from about 45 wt % to about 50 wt % hydrophobic polymer. In some embodiments, the structured sorbent includes about 1 wt %, about 5 wt %, about 10 wt %, about 15 wt %, about 20 wt %, about 25 wt %, about 30 wt %, about 35 wt %, about 40 wt %, about 45 wt %, or about 50 wt % hydrophobic polymer.

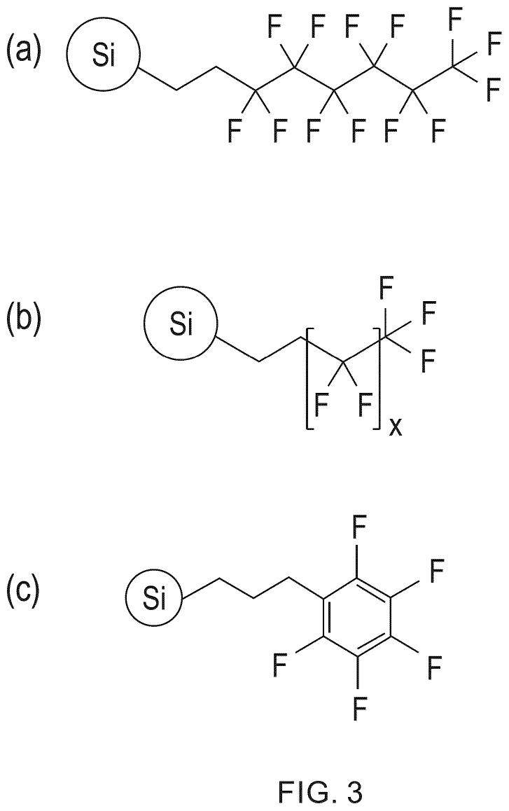

The structured sorbents of the present disclosure also include a hydrophobic carrier. In some embodiments, the hydrophobic carrier is fluoro-functionalized silica (F-SiO₂). Fluoro-functionalized silica is a superhydrophobic material that can provide water sliding angles of less than 10°. FIG. 3 shows example fluorinated silica compositions (a) tridecafluoro-derivatized silica gel, (b) fluorochrome-derivatized silica gel, and (c) pentafluorophenyl-derivatized silica gel. These compositions are suitable for use in the structured sorbents. Other suitable fluoro-functionalized silicas include perfluorocyclopentene functionalized silica and trifluoropropylmethyl functionalized silica. In some embodiments, the fluorinated silicas have particle sizes of 5 μm to 60 μm in diameter. In some embodiments, fluorinated silica is incorporated into the structured sorbents at about 0.1 wt % to about 30 wt %. For example, from about 0.1 wt % to about 25 wt %, from about 0.1 wt % to about 20 wt %, from about 0.1 wt % to about 15 wt %, from about 0.1 wt % to about 10 wt %, from about 0.1 wt % to about 5 wt %, or from about 0.1 wt % to about 1 wt %. In some embodiments, fluorinated silica is incorporated into the structured sorbent at about 0.5 wt % to about 30 wt %, from about 1 wt % to about 30 wt %, from about 5 wt % to about 30 wt %, from about 10 wt % to about 30 wt %, from about 15 wt % to about 30 wt %, from about 20 wt % to about 30 wt %, or from about 25 wt % to about 30 wt %. In some embodiments, the fluorinated silica is incorporated into the structured sorbent at about 0.1 wt %, 0.5 wt %, about 1 wt %, about 5 wt %, about 10 wt % about 15 wt %, about 20 wt %, about 35 wt %, or about 30 wt %.

In some embodiments, the structured sorbents include 95 wt % NbOF₅-Ni MOF and 5 wt % PVDF. In some embodiments, the structured sorbents include 90 wt % NbOF₅-Ni MOF and 10 wt % PVDF. In some embodiments, the structured sorbents include 80 wt % NbOF₅-Ni MOF and 20 wt % PVDF. In some embodiments, the structured sorbents include 70 wt % NbOF₅-Ni MOF and 30 wt % PVDF. In some embodiments, the structured sorbents include 60 wt % NbOF₅-Ni MOF and 40 wt % PVDF. In some embodiments, the structured sorbents include 50 wt % NbOF₅-Ni MOF and 50 wt % PVDF.

In some embodiments, the structured sorbent includes 89.55 wt % NbOF₅-Ni MOF, 9.95 wt % PVDF, and 0.5 wt % F-SiO₂. In some embodiments, the structured sorbents include 89.1 wt % NbOF₅-Ni MOF, 9.9 wt % PVDF, and 1 wt % F-SiO₂. In some embodiments, the structured sorbents include 88.2 wt % NbOF₅-Ni MOF, 9.8 wt % PVDF, and 1.96 wt % F-SiO₂. In some embodiments, the structured sorbents include 86.6 wt % NbOF₅-Ni MOF, 9.6 wt % PVDF, and 3.8 wt % F-SiO₂. In some embodiments, the structured sorbents include 90 wt % NbOF₅-Ni MOF, 5 wt % PVDF, and 5 wt % F-SiO₂. In some embodiments, the structured sorbents include 75 wt % NbOF₅-Ni MOF, 20 wt % PVDF, and 5 wt % F-SiO₂.

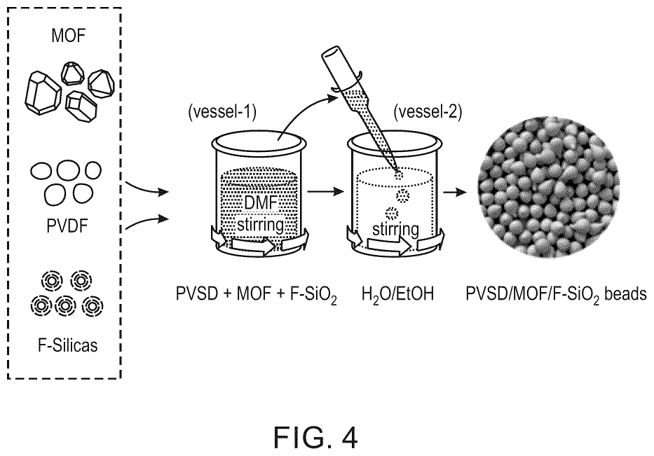

In some embodiments, the structured sorbents are synthesized via a phase inversion process. FIG. 4 shows a schematic of an example phase inversion process. In a phase inversion process, a MOF, binder, and hydrophobic carrier are dissolved in a first solvent to form a first solution. In some embodiments, the first solution is heated to increase the rate at which the binder dissolves. In some embodiments, the first solution is heated to 25 to 80° C. The temperature is related to the concentration of the polymer or binder, since the polymer needs to dissolve in the organic solvent. For example, at a low binder/MOF ratio of 5/95 w/w, the polymer will dissolve in 2-3 hours in DMF. However, when the binder/MOF ratio increases, the polymer will dissolve more slowly. An increase in temperature will increase the rate at which the polymer dissolves. In some embodiments, the temperature range is 35 to 60° C. FIG. 4 shows an example phase inversion process where the binder is PVDF, the hydrophobic carrier is F-SiO₂, and the first solvent is DMF. However, other binders, hydrophobic carriers, and solvents can be used. For example, the first solvent can be an organic solvent. Suitable organic solvents include, but are not limited to, dimethylformamide (DMF), N-methyl-2-pyrrolidone (NMP), dimethylacetamide (DMAc), triethyl phosphate (TEP), hexamethylphosphoramide (HMPA), and trimethylphosphate (TMP).

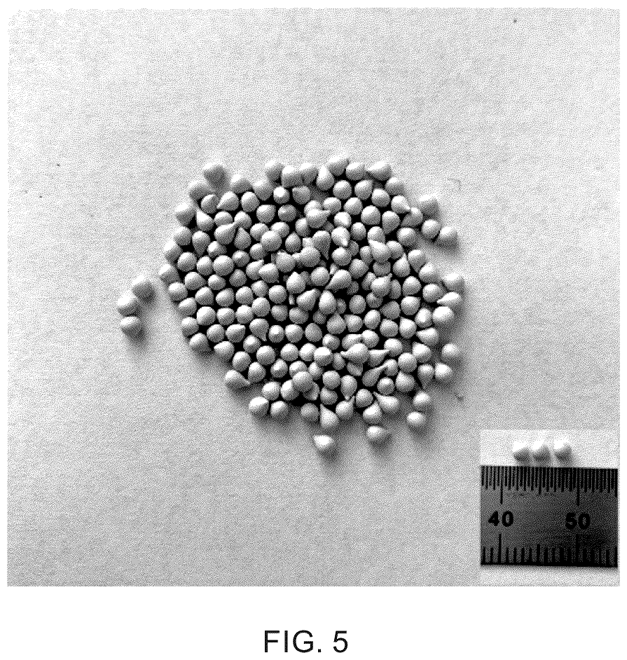

As shown in FIG. 4, the first solution is then introduced into a second solution. In some embodiments, the first solution is introduced dropwise into a second solution. The second solution includes a mixture water and ethanol. When the first solution is introduced dropwise into the second solution, solid beads of structured sorbents form and precipitate directly. FIG. 5 shows an example photograph of PVDF/NbOF₅-Ni MOF/F-SiO₂ beads formed using a phase inversion process. The units of the reference ruler in FIG. 5 are cm, with the distance between the visible “40” and “50” markings indicating a 10 cm difference.

As disclosed herein, a method of synthesizing structured sorbents includes preparing a binder solution. Preparing a binder solution can include dissolving a hydrophobic polymer in an organic solvent. In some embodiments, the hydrophobic polymer includes polystyrene-block-polybutadiene-block-polystyrene (SBS), polyvinylidene difluoride (PVDF), polyacrylonitrile (PAN), or any combination thereof. In some embodiments, the organic solvent includes dimethylformamide (DMF), N-methyl-2-pyrrolidone (NMP), dimethylacetamide (DMAc), triethyl phosphate (TEP), hexamethylphosphoramide (HMPA), or trimethylphosphate (TMP). In some embodiments, preparing the binder solution includes heating the binder solution. In some embodiments, the concentration of the hydrophobic polymer in the binder solution is 5-50% by weight. For example, the concentration of the hydrophobic polymer in the binder solution can be from 5 wt % to 45 wt %, from 5 wt % to 40 wt %, from 5 wt % to 35 wt %, from 5 wt % to 30 wt %, from 5 wt % to 25 wt %, from 5 wt % to 20 wt %, from 5 wt % to 15 wt %, from 5 wt % to 10 wt %, or from 5 wt % to 5 wt %. In some embodiments, the concentration of the hydrophobic polymer in the binder solution is from 5 wt % to 50 wt %, from 10 wt % to 50 wt %, from 15 wt % to 50 wt %, from 20 wt % to 50 wt %, from 25 wt % to 50 wt %, from 30 wt % to 50 wt %, from 35 wt % to 50 wt %, from 40 wt % to 50 wt %, or from 45 wt % to 50 wt %. In some embodiments, the concentration of the hydrophobic polymer in the binder solution can be from about 5 wt %, about 10 wt %, about 15 wt %, about 20 wt %, about 25 wt %, about 30 wt %, about 35 wt %, about 40 wt %, about 45 wt %, or about 50 wt %.

The method of the present disclosure includes preparing a hydrophobic carrier suspension. In some embodiments, preparing a hydrophobic carrier suspension includes dispersing fluorinated silica in an organic solvent. In some embodiments, the organic solvent includes dimethylformamide (DMF), N-methyl-2-pyrrolidone (NMP), dimethylacetamide (DMAc), triethyl phosphate (TEP), hexamethylphosphoramide (HMPA), or trimethylphosphate (TMP). In some embodiments, preparing the hydrophobic carrier suspension includes heating the hydrophobic carrier suspension. In some embodiments, the concentration of the hydrophobic carrier in the suspension is about 0.1 wt % to about 30 wt %. For example, from about 0.1 wt % to about 25 wt %, from about 0.1 wt % to about 20 wt %, from about 0.1 wt % to about 15 wt %, from about 0.1 wt % to about 10 wt %, from about 0.1 wt % to about 5 wt %, or from about 0.1 wt % to about 1 wt %. In some embodiments, the concentration of the hydrophobic carrier in the suspension is from about 0.5 wt % to about 30 wt %, from about 1 wt % to about 30 wt %, from about 5 wt % to about 30 wt %, from about 10 wt % to about 30 wt %, from about 15 wt % to about 30 wt %, from about 20 wt % to about 30 wt %, or from about 25 wt % to about 30 wt %.

The method of the present disclosure includes mixing the binder solution and the hydrophobic carrier suspension to form a slurry. In some embodiments, the method includes adding a MOF to the slurry to form a dope solution. In some embodiments, the MOF is NbOF₅-Ni MOF. In some embodiments, the MOF is added at an amount to provide 50-95 wt % of the total composite sorbent. In some embodiments, the MOF is mixed in the slurry overnight at 25-85° C.

The method of the present disclosure includes adding the dope solution dropwise to a quench bath to precipitate the structured sorbents. In some embodiments, the dope solution is added dropwise via a syringe. In some embodiments, the quench bath is an H₂O/ethanol bath. In some embodiments, the quench bath is 5:1 v/v H₂O/ethanol.

In some embodiments, the method includes washing the structured sorbents with a solvent. In some embodiments, the solvent is methanol. In some embodiments, the method includes drying the structured sorbents. In some embodiments, the structured sorbents are dried in a vacuum oven.

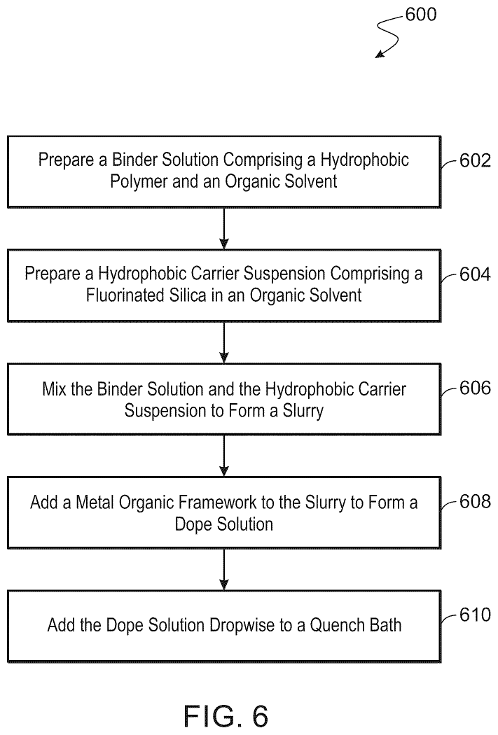

FIG. 6 is a flowchart of an example method 600 of making a structured sorbent. At 602, a binder solution is prepared, where the binder solution includes a hydrophobic polymer and an organic solvent. In some embodiments, the hydrophobic polymer includes polystyrene-block-polybutadiene-block-polystyrene (SBS), polyvinylidene difluoride (PVDF), polyacrylonitrile (PAN), or any combination thereof. In some embodiments, the organic solvent includes dimethylformamide (DMF), N-methyl-2-pyrrolidone (NMP), dimethylacetamide (DMAc), triethyl phosphate (TEP), hexamethylphosphoramide (HMPA), or trimethylphosphate (TMP). In some embodiments, preparing the binder solution includes heating the binder solution. In some embodiments, the concentration of the hydrophobic polymer in the binder solution is 5-50% by weight. For example, the concentration of the hydrophobic polymer in the binder solution can be from 5 wt % to 45 wt %, from 5 wt % to 40 wt %, from 5 wt % to 35 wt %, from 5 wt % to 30 wt %, from 5 wt % to 25 wt %, from 5 wt % to 20 wt %, from 5 wt % to 15 wt %, from 5 wt % to 10 wt %, or from 5 wt % to 5 wt %. In some embodiments, the concentration of the hydrophobic polymer in the binder solution is from 5 wt % to 50 wt %, from 10 wt % to 50 wt %, from 15 wt % to 50 wt %, from 20 wt % to 50 wt %, from 25 wt % to 50 wt %, from 30 wt % to 50 wt %, from 35 wt % to 50 wt %, from 40 wt % to 50 wt %, or from 45 wt % to 50 wt %.

At 604, a hydrophobic carrier suspension is prepared, where the hydrophobic carrier suspension includes fluorinated silica in an organic solvent. In some embodiments, the organic solvent includes dimethylformamide (DMF), N-methyl-2-pyrrolidone (NMP), dimethylacetamide (DMAc), triethyl phosphate (TEP), hexamethylphosphoramide (HMPA), or trimethylphosphate (TMP). In some embodiments, preparing the hydrophobic carrier suspension includes heating the hydrophobic carrier suspension. In some embodiments, the concentration of the hydrophobic carrier in the suspension is about 0.1 wt % to about 30 wt %. For example, from about 0.1 wt % to about 25 wt %, from about 0.1 wt % to about 20 wt %, from about 0.1 wt % to about 15 wt %, from about 0.1 wt % to about 10 wt %, from about 0.1 wt % to about 5 wt %, or from about 0.1 wt % to about 1 wt %. In some embodiments, the concentration of the hydrophobic carrier in the suspension is from about 0.5 wt % to about 30 wt %, from about 1 wt % to about 30 wt %, from about 5 wt % to about 30 wt %, from about 10 wt % to about 30 wt %, from about 15 wt % to about 30 wt %, from about 20 wt % to about 30 wt %, or from about 25 wt % to about 30 wt %.

At 606, the binder solution and the hydrophobic carrier suspension are mixed to form a slurry. At 608, a metal organic framework (MOF) is added to the slurry to form a dope solution. In some embodiments, the MOF is NbOF₅-Ni MOF. In some embodiments, the MOF is added at an amount to provide 50-95 wt % of the total composite sorbent. In some embodiments, the MOF is mixed in the slurry overnight at 25-85° C.

At 610, the dope solution is added dropwise to a quench bath.

In some embodiments, the dope solution is added dropwise via a syringe. In some embodiments, the quench bath is an H₂O/ethanol bath. In some embodiments, the quench bath is 5:1 v/v H₂O/ethanol.

In some embodiments, the method includes washing the structured sorbents with a solvent. In some embodiments, the solvent is methanol. In some embodiments, the method includes drying the structured sorbents. In some embodiments, the structured sorbents are dried in a vacuum oven.

The structured sorbents described herein can be used to capture carbon from the air. The structured sorbents described herein include an MOF framework. The framework includes crystalline materials with a cage-like structure and nanoscale pores. The pores can act as molecular traps, capable of selectively capturing gases, including CO₂. A method of carbon capture includes contacting a structured sorbent as described herein with a CO₂ containing feed stream. In some embodiments, the feed stream is a flue gas. In some embodiments, the feed stream includes about 400 ppm CO₂. For example, the feed stream can include from 100-1000, 100-900, 100-800, 100-700, 100-600, 100-500, 100-400, 100-300, 100-200, 200-1000, 300-1000, 400-1000, 500-1000, 600-1000, 700-1000, 800-1000, or 900-1000 ppm CO₂. In some embodiments, the feed stream includes 100, 200, 300, 400, 500, 600, 700, 800, 900, or 1000 ppm CO₂. The feed stream passes over and/or through the structured sorbents, and CO₂ in the feed stream is adsorbed to yield a CO₂ depleted stream and a CO₂-loaded structured sorbent. In some embodiments, the CO₂ depleted stream is released to the atmosphere. The CO₂-loaded structured sorbent is then hydraulically isolated from the feed stream. The CO₂ in the CO₂-loaded structured sorbent is recovered and the structured sorbent is regenerated. In some embodiments, the structured sorbent is regenerated and the captured CO₂ is recovered from the sorbent using temperature, steam, and/or vacuum means, for example a vacuum swing adsorption process. In some embodiments, the regenerated structured sorbent is re-exposed to the feed stream.

The structured sorbents described herein can also capture CO₂ from air or point sources. For example, the structured sorbents can be used to capture CO₂ from streams with a low CO₂ concentration, e.g., 1 to 6% v/v CO₂. The structured sorbents can also be used to capture CO₂ at higher concentrations, for example, 5 to 15% v/v CO₂. The structured sorbents described herein can be used to capture CO₂ from flue gas, industrial sources, air, and other CO₂ containing gases. The structured sorbents can capture CO₂ from sources that include 1-15% v/v CO₂, for example, 1-14%, 1-13%, 1-12%, 1-11%, 1-10%, 1-9%, 1-8%, 1-7%, 1-6%, 1-5%, 1-4%, 1-3%, 1-2%, 2-15%, 3-15%, 4-15%, 4-15%, 5-15%, 6-15%, 7-15%, 8-15%, 9-15%, 10-15%, 11-15%, 12-15%, 13-15%, or 14-15% v/v CO₂. In some embodiments, the structured sorbents described herein capture CO₂ from a source that includes 1%, 2%, 3%, 4%, 5%, 6%, 7%, 8%, 9%, 10%, 11%, 12%, 13%, 14%, or 15% v/v CO₂.

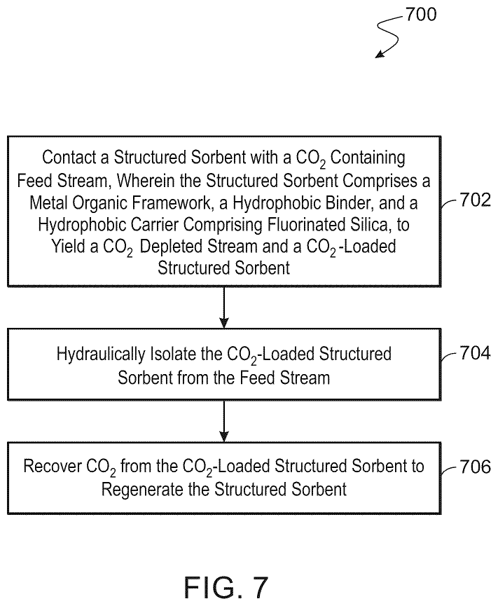

FIG. 7 is a flowchart of an example method 700 of capturing carbon using a structured sorbent. At 702, a structured sorbent is contacted with a CO₂ containing feed stream. The structured sorbent includes a metal organic framework, a hydrophobic binder, and a hydrophobic carrier. The hydrophobic carrier includes fluorinated silica.

In some embodiments, the metal organic framework includes NbOF₅-Ni MOF. In some embodiments, the metal organic framework includes 50-95 wt % of the structured sorbent. In some embodiments, the hydrophobic binder includes a hydrophobic polymer. In some embodiments, the hydrophobic polymer includes polystyrene-block-polybutadiene-block-polystyrene (SBS), polyvinylidene difluoride (PVDF), polyacrylonitrile (PAN), or any combination thereof. In some embodiments, the hydrophobic binder includes 1-50 wt % of the structured sorbent. In some embodiments, the fluorinated silica includes tridecafluoro-derivatized silica gel, fluorochrome-derivatized silica gel, pentafluorophenyl-derivatized silica gel, perfluorocyclopentene functionalized silica, or trifluoropropylmethyl functionalized silica. In some embodiments, the fluorinated silica includes fluorinated silica particles, wherein the fluorinated silica particles are 5 μm to 60 μm in diameter. In some embodiments, the fluorinated silica includes 0.1-30 wt % of the structured sorbent. In some embodiments, the metal organic framework includes NbOF₅-Ni MOF and the hydrophobic binder includes PVDF. In some embodiments, the structured sorbent includes 90 wt % NbOF₅-Ni MOF, 5 wt % PVDF, and 5 wt % fluorinated silica. In some embodiments, the structured sorbent includes 75 wt % NbOF₅-Ni MOF, 20 wt % PVDF, and 5 wt % fluorinated silica.

In some embodiments, the feed stream is a flue gas. In some embodiments, the flue gas is a combustion exhaust gas that includes nitrogen, CO₂, water vapor, and oxygen. In some embodiments, the feed stream includes about 400 ppm CO₂. For example, the feed stream can include from 100-1000, 100-900, 100-800, 100-700, 100-600, 100-500, 100-400, 100-300, 100-200, 200-1000, 300-1000, 400-1000, 500-1000, 600-1000, 700-1000, 800-1000, or 900-1000 ppm CO₂. In some embodiments, the feed stream includes 100, 200, 300, 400, 500, 600, 700, 800, 900, or 1000 ppm CO₂. The feed stream passes over and/or through the structured sorbents, and CO₂ in the feed stream is adsorbed to yield a CO₂ depleted stream and a CO₂-loaded structured sorbent. In some embodiments, the CO₂ depleted stream is released to the atmosphere. At 704, the CO₂-loaded structured sorbent is isolated from the feed stream. At 706, CO₂ is recovered from the CO₂-loaded structured sorbent and the sorbent is regenerated. In some embodiments, the structured sorbent is regenerated and the captured CO₂ is recovered from the sorbent using temperature, steam, and/or vacuum means, for example a vacuum swing adsorption process. In some embodiments, the regenerated structured sorbent is re-exposed to the feed stream.

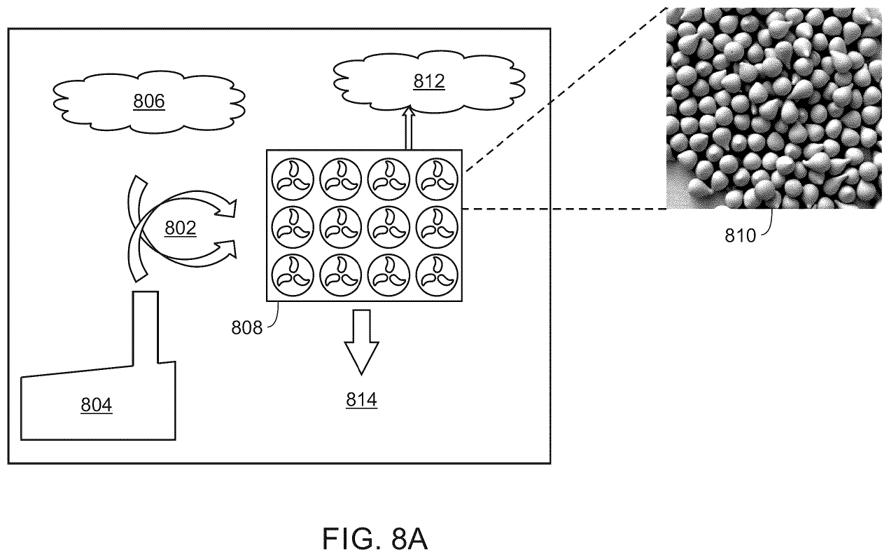

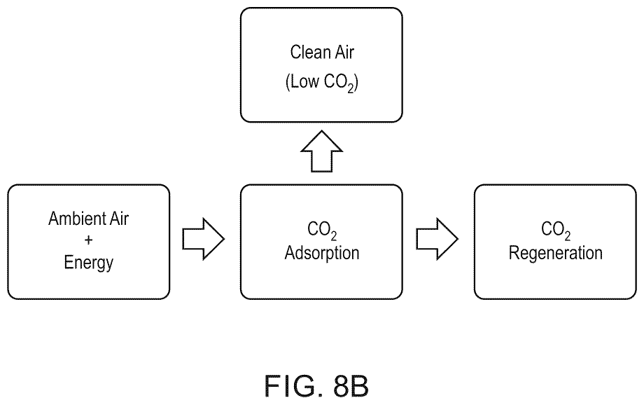

FIG. 8A shows an example schematic of direct air capture of CO₂ using structured sorbents. A CO₂ containing gas 802 is directed to a direct air capture unit 808. The CO₂ containing gas can be a mixture of ambient air 806 or a gas produced by an industrial unit 804. The direct air capture unit 808 includes structured sorbents 810 as described herein. The direct air capture unit 808 produces clean air 812, i.e., air that has been at least partially depleted of CO₂. The direct air capture unit 808 also produces captured CO₂ 814. FIG. 8B is a flowchart of an example embodiment of direct air capture, wherein ambient air and energy is subjected to CO₂ adsorption via the structured sorbents described herein. The adsorption process yields clean air, i.e., low CO₂ air. The CO₂ can be regenerated from the structured sorbents.

### Example 1: Fabrication of PVDF/NbOF₅-Ni MOF/F-SiO₂ Composite Beads

Dried PVDF (MW=350k to 670k) was dissolved in an organic solvent at 25-85° C. with a concentration of 5-50 wt %. Fluorinated silica was dispersed in an organic solvent with a concentration of 0.5-10 wt % and then mixed at room temperature for 10 to 30 minutes. The prepared F-SiO₂ solution was then added to the PVDF solution. Subsequently, the mixture was stirred for about 10 to 30 minutes to ensure homogenous dispersion of F-SiO₂ particles in the PVDF solution. Next, an amount of dried NbOF₅-Ni MOF powder (50-95 wt % of the total composite sorbent) was added to the primed PVDF/F-SiO₂ solution and stirred mechanically at 25-80° C. overnight. The obtained PVDF/NbOF₅-Ni MOF/F-SiO₂ slurry was loaded into a 10-25 mL syringe with a needle size of 19-24 gauge (0.31-0.68 mm inner diameter). The syringe was installed on a syringe pump and then the slurry was vertically dropped into a non-solvent solution of a quench bath (water/ethanol, 5:1 v/v). Solid beads formed and precipitated directly after contact of the slurry with the water/ethanol bath. The beads were placed in a coagulation bath including a water/ethanol mixture (5:1 v/v) for 60 mins, and the solution in the bath was exchanged with a fresh non-solvent three times over a 24 hour period. Thereafter, the beads were collected and soaked in methanol for 1 day, followed by methanol exchange twice a day. The obtained methanol-soaked PVDF/NbOF₅-Ni MOF/F-SiO₂ beads were dried overnight at ambient temperature (approximately 22° C.) and then dried in a vacuum oven at 90-100° C. overnight. The dried millimeter-size beads were then stored in a vacuum desiccator for further characterization.

### Example 2: Fabrication of PVDF/NbOF₅-Ni MOF/F-SiO₂ Composite Beads

1.6 g of dried polyvinylidene fluoride (PVDF) (Solvay, MW=573k) was fully dissolved in dimethylformamide (DMF) (10 mL) and then stirred at 80° C. to obtain a transparent PVDF solution with uniform viscosity. 0.4 g of fluorinated silica (F-SiO₂) (Si-TDF from SiliCycle's) was dispersed in 10 mL of DMF and mixed at room temperature for about 10 to 30 minutes. The prepared F-SiO₂ suspension was then added to the PVDF solution. The mixture was subsequently sonicated at ambient temperature (approximately 22° C.) for 30 minutes to ensure homogenous dispersion of F-SiO₂ particles in PVDF solution. Next, 6.0 g of dried NbOF₅-Ni MOF powder was added to the PVDF/F-SiO₂ solution and then mixed mechanically at 25 to 80° C. overnight. The obtained PVDF/NbOF₅-Ni MOF/F-SiO₂ slurry was loaded into a 0-25 mL syringe with a straight probe size of 9-24 gauge (0.31-0.68 mm inner diameter). The syringe was installed on a syringe pump and then the slurry was vertically dropped into a water/ethanol (5:1 v/v) non-solvent solution. Solid beads precipitated directly after contact with the solution by the solvent/water exchange. The beads were placed in a coagulation bath for 60 minutes. Next, the solution in the bath was exchanged with a fresh non-solvent three times. Thereafter, the beads were collected and soaked in methanol, followed by methanol exchange twice. The obtained methanol-soaked PVDF/NbOF₅-Ni MOF/F-SiO₂ beads were dried overnight in a fume hood and then dried in a vacuum oven at 90 to 110° C. overnight. The dried beads (approximately 1-2 mm in diameter) were stored in a vacuum desiccator for further characterization.

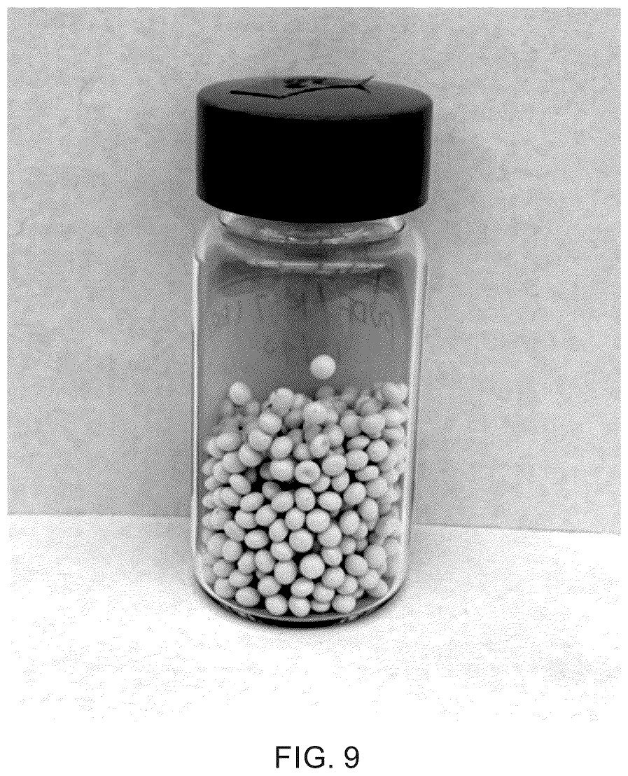

FIG. 9 is a photograph of example PVDF/NbOF₅-Ni MOF/F-SiO₂ beads (20/70/5 wt %) produced via the phase inversion process described in this example.

### Example 3: Fabrication of PVDF/NbOF₅-Ni MOF Composite Beads, Comparative Sorbent

0.6 g of dried PVDF (Solvay, MW=573 k) was fully dissolved in 9 mL of DMF and then stirred at 80° C. to obtain a transparent PVDF solution with uniform viscosity. 5.4 g of the dried NbOF₅-Ni MOF powder was added into the PVDF solution and stirred at 25-80° C. overnight. The obtained PVDF/NbOF₅-Ni MOF slurry was loaded into a 10 ml syringe with a straight probe size of 19-24 gauge (0.31-0.68 mm inner diameter). The syringe was installed on a syringe pump and then the slurry was vertically dropped into water/ethanol (5:1) non-solvent solution. Solid beads were precipitated directly after contact with the solution by the solvent/water exchange. The beads were placed in a coagulation bath for 60 min, and then solution in the bath was exchanged with a fresh non-solvent three times over the course of a 24 hour period. Thereafter, the beads were collected and soaked in methanol, followed by methanol exchange twice. The obtained methanol-soaked PVDF/NbOF₅-Ni MOF beads were dried overnight in a fume hood and then dried in a vacuum over at 90-100° C. overnight. The dried beads (approximately 1-2 mm in diameter) were stored in the vacuum desiccator for further characterization.

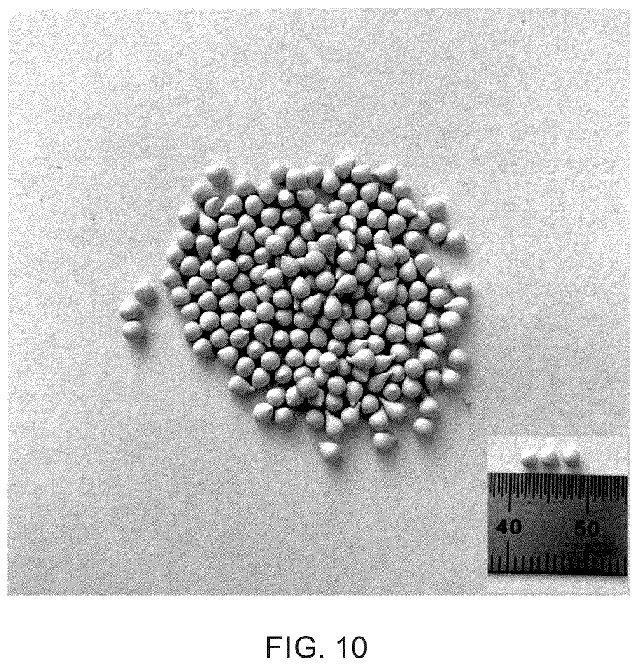

FIG. 10 is an example photograph of PVDF/NbOF₅-Ni MOF (10/90 wt %) beads produced via the phase inversion process described in this example. The units of the reference ruler in FIG. 10 are cm, with the distance between the visible “40” and “50” markings indicating a 10 cm difference.

### Example 4: Fabrication of PMMA/NbOF₅-Ni MOF Solid Sorbent (Templated), Comparative Sorbent

The formation of PMMA/NbOF₅-Ni MOF sorbent was performed through a templated drying process. 0.2 g of poly(methylmethacrylate) (PMMA) (Sigma, MW=350k) was added in 6 mL of chloroform (CHCl₃) and stirred at temperature (approximately 22° C.) to obtain a transparent PMMA solution. 1.8 g of the dried NbOF₅-Ni MOF powder was suspended in 6 mL of CHCl₃, and sonicated at room temperature for 10 min. Next, the clear solution of PMMA was added to the NbOF₅-Ni MOF MOF/CHCl₃ solution. The mixture was then sonicated for 10 minutes. The mixture was placed in a glass vial and rolled on a roller mixer overnight at ambient temperature (approximately 22° C.) to completely dissolve the polymer. After rolling overnight, the excess CHCl₃ was removed via flashing air and/or N₂ in a fume hood to yield a thin paste. The thin paste was then placed in a Corticosteron Pellet mold (4.5×4.5×5 mm Peloc® Microwell Staining Mold) to give the desired shaped body. The shaped materials were then dried overnight in air flow in a fume hood to form hard cubes. The shaped PMMA/NbOF₅-Ni MOF sorbents were further dried in an over at 100° C. overnight.

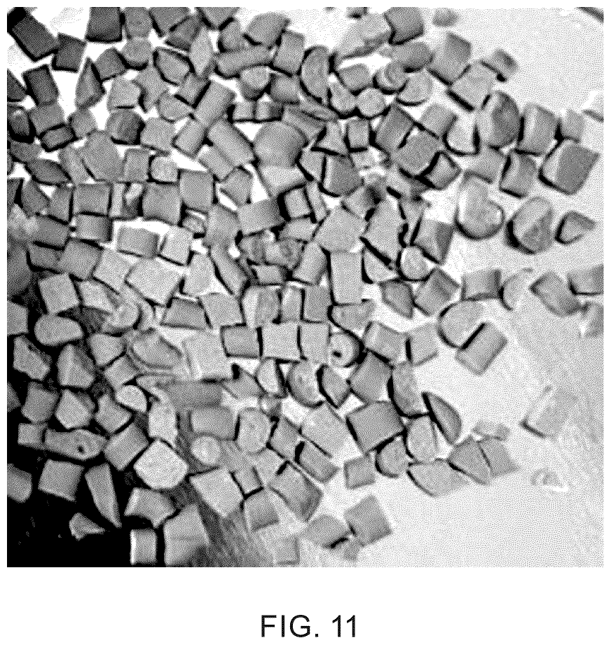

FIG. 11 is an example photograph of the PMMA/NbOF₅-Ni MOF cubes (templated sorbent) produced in this example.

### Example 5: Characterization of Structured Sorbents

### Scanning Electron Microscopy

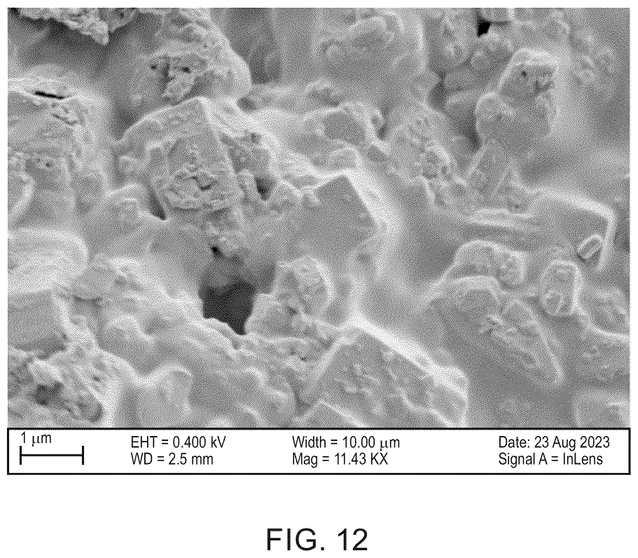

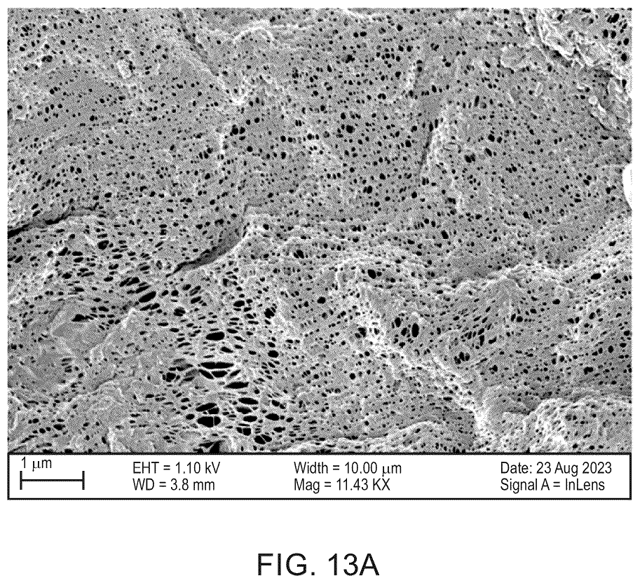

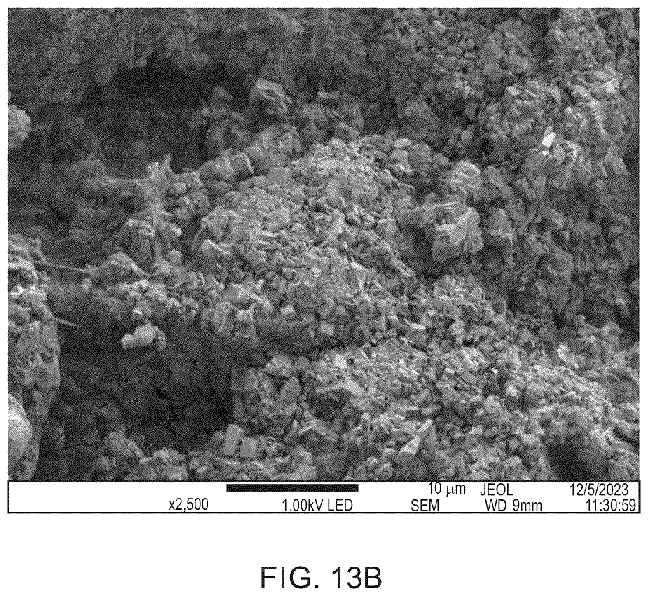

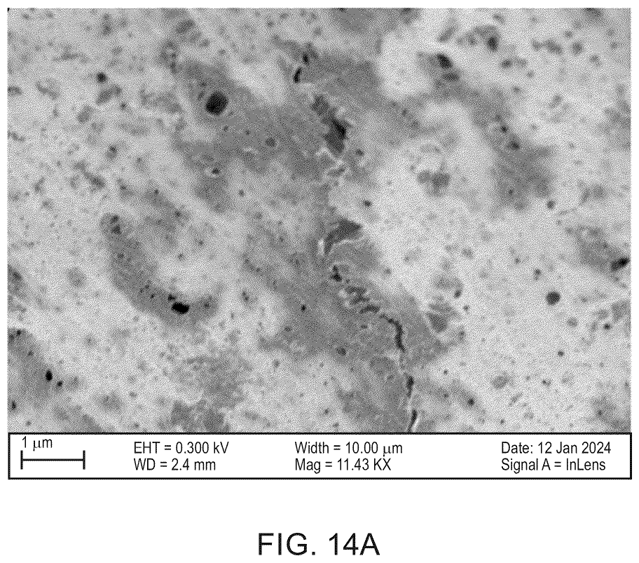

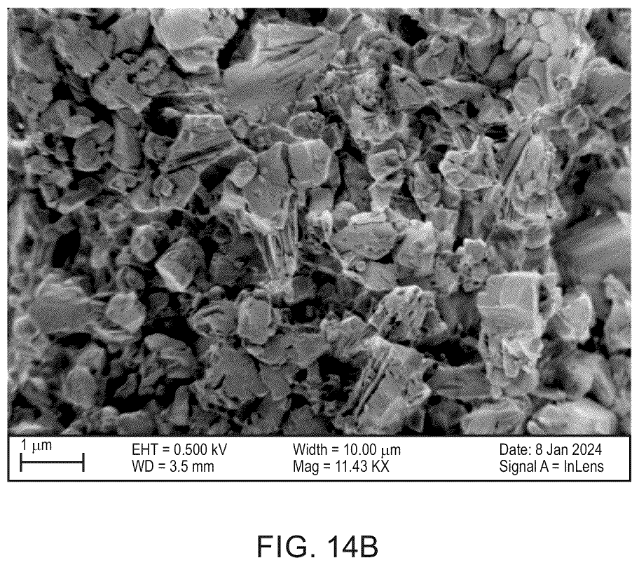

Scanning electron microscopy (SEM) images of the shaped sorbents were recorded by using Zeiss Gemini 560 SEM. Samples were prepared by depositing the sorbents on carbon tape and sputtering with Pt for 45 seconds. FIG. 12 is an example SEM image of the PMMA/NbOF₅-Ni MOF cube sorbents formed through the templated drying process of Example 4. FIG. 12 shows the outer surface of the PMMA/NbOF₅-Ni MOF cube sorbent. As shown in FIG. 12, the PMMA/NbOF₅-Ni MOF cube sorbents are made of a continuous phase. In contrast, FIG. 13A and FIG. 13B show SEM images of the PVDF/NbOF₅-Ni MOF beads synthesized using the phase inversion process of Example 3. FIG. 13A is the outer surface of the PVDF/NbOF₅-Ni MOF beads. As shown in FIG. 13A, there are a number of holes on the bead surface. FIG. 13B shows a cross-section of the PVDF/NbOF₅-Ni MOF beads. As shown in FIG. 13B, there are porous structures inside of the beads. FIG. 14A and FIG. 14B show example SEM images of PVDF/NbOF₅-Ni MOF/F-SiO₂ beads synthesized via the phase inversion process of Example 2. FIG. 14A shows the outer surface of the PVDF/NbOF₅-Ni MOF/F-SiO₂ beads. As shown in FIG. 14A, there are a number of holes on the bead surface. FIG. 14B shows a cross-section of the PVDF/NbOF₅-Ni MOF/F-SiO₂ beads. As shown in FIG. 14B, there are porous structures inside of the beads.

The SEM images demonstrate that the PVDF/NbOF₅-Ni MOF and PVDF/NbOF₅-Ni MOF/F-SiO₂ beads show higher surface porosity and an open network, compared to the dense templated synthesized PMMA/NbOF₅-Ni MOF sorbents. The higher surface porosity and open network leads to fast mass transport.

### H₂O Static Contact Angles

The H₂O static contact angles (CA) of the shaped sorbents were measured using Ramé-Hart Model 250 contact angle goniometer (Ramé-Hart Instrument Co.), and each test was repeated three times to obtain the average CA. PVDF/NbOF₅-Ni MOF and PVDF/NbOF₅-Ni MOF/F-SiO₂ flat sheet membranes were prepared using the same formulation through a phase inversion process. The flat sheet was prepared with the same polymer/MOF mixtures. For a flat sheet, the mixture is first casted on the glass plate, and immediately soak the glass plate into non-solvent bath, then a thin layer of flat sheet membrane is formed and peeled off from the glass plate.

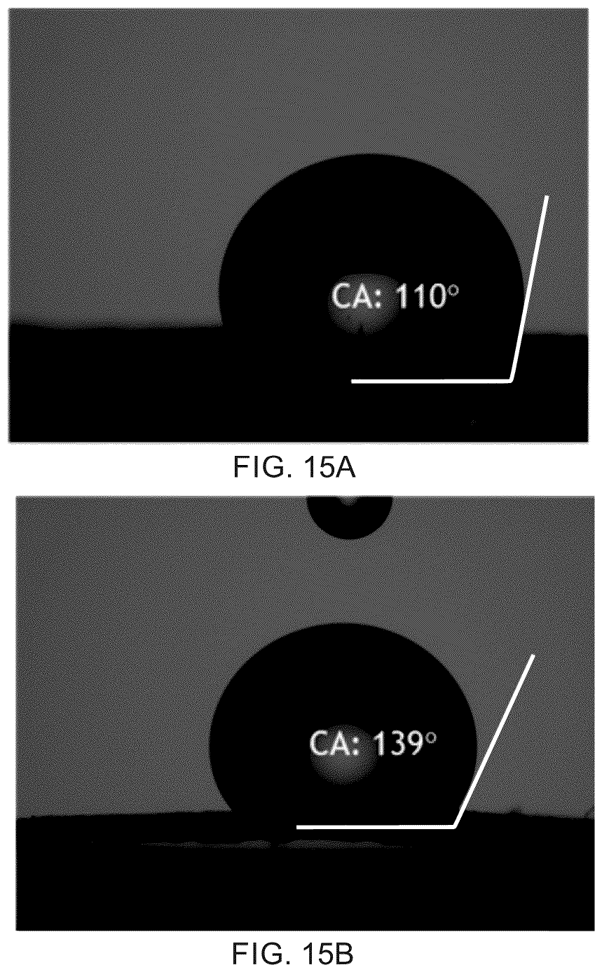

A water droplet test was performed. FIG. 15A shows an example water drop test on a PVDF/NbOF₅-Ni MOF flat membrane. The average contact angle for PVDF/NbOF₅-Ni MOF was 110 degrees. FIG. 15B shows an example water drop test on a PVDF/NbOF₅-Ni MOF/F-SiO₂ flat membrane. The average contact angle for PVDF/NbOF₅-Ni MOF/F-SiO₂ was 139 degrees. The higher contact angle indicates increased hydrophobicity. Accordingly, the water drop tests illustrate the enhanced hydrophobicity of the composite beads with the inclusion of fluorinated silica into the sorbent matrix.

### Thermal Stability

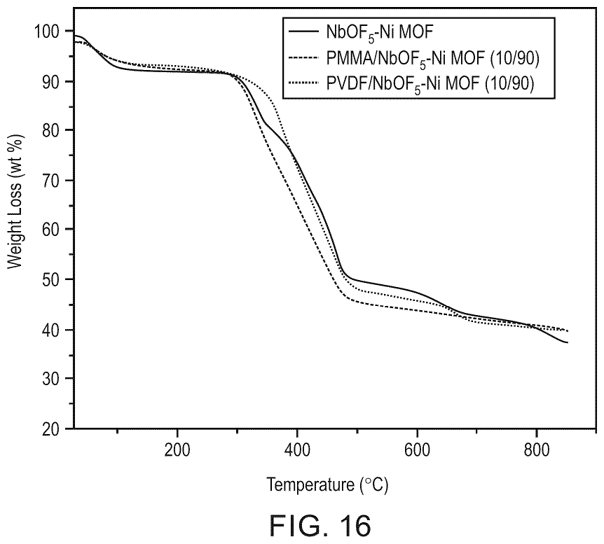

Thermal stability was measured using thermogravimetric analysis (Discovery TGA, 30 to 800° C. at a scanning rate of 10° C./min). FIG. 16 shows example TGA curves of NbOF₅-Ni MOF powder (solid line) compared to a PMMA/NbOF₅-Ni MOF sorbent (dashed line) and a PVDF/NbOF₅-Ni MOF sorbent (dotted line). The results of the TGA analysis show that the shaped sorbents display thermal stability up to 300° C., indicating that mixing the polymer binder (e.g., PMMA or PVDF) into NbOF₅-Ni MOF matrix did not affect the stability of the structured sorbents.

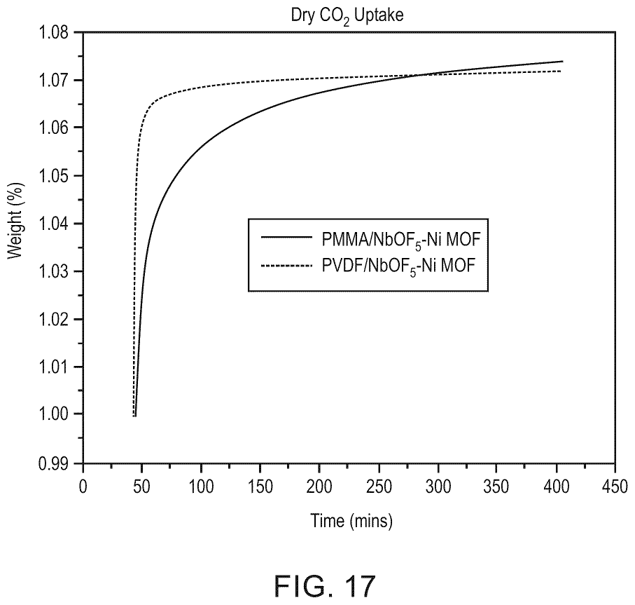

In addition, the CO₂ sorption of structured sorbents was studied by TGA. FIG. 17 shows the results of a CO₂ sorption study of PMMA/NbOF₅-Ni MOF (10/90 w/w) sorbent and PVDF/NbOF₅-Ni MOF (10/90 w/w) sorbent. The results in FIG. 17 show that the phase inversion synthesized PVDF-NbOF₅-Ni MOF beads performed faster CO₂ uptake than the templated drying synthesized PMMA/NbOF₅-Ni MOF cubes under the same composition and testing conditions.

### CO₂ Adsorption

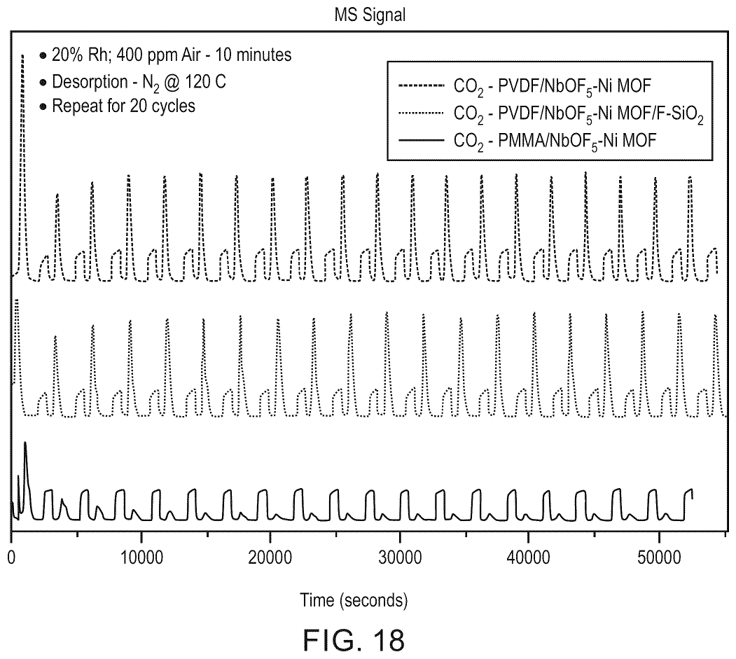

To examine CO₂ adsorption, the working capacities of the structured sorbents were measured by TGA connected with a gas analyzer under humid conditions (20% RH, 400 ppm CO₂). CO₂ adsorption at these conditions was performed by thermogravimetric analysis (TGA) (TA Instruments Discovery TGA) equipped with a gas analyzer. Before exposure to the CO₂-containing gas, the structured sorbents were pretreated under N₂ flow at 100° C. for 30 minutes. The CO₂ and H₂O of the outlet gas stream were continuously measured by OmniStar GSD 350 gas analyzer (Pfeiffer Vacuum). FIG. 18 shows a comparison of CO₂ cyclic sorption (20 cycles) for the templated PMMA/NbOF₅-Ni MOF cubes and the phase inversion synthesized PVDF/NbOF₅-Ni MOF beads and PVDF/NbOF₅-Ni MOF/F-SiO₂ beads under 400 ppm CO₂ in air at 20% RH for 10 minutes. Desorption in FIG. 18 was performed under N₂ at 120° C. The results show that the phase inversion synthesized PVDF/NbOF₅-Ni MOF beads and the PVDF/NbOF₅-Ni MOF/F-SiO₂ beads show higher peak intensities compared to the templated PMMA/NbOF₅-Ni MOF cubes, indicating significantly more CO₂ release than that of templated PMMA/NbOF₅-Ni MOF cubes. There was a smaller CO₂ increase between the phase inversion synthesized sorbents for the PVDF/NbOF₅-Ni MOF and PVDF/NbOF₅-Ni MOF/F-SiO₂ beads, presumably due to their similar porous structures.

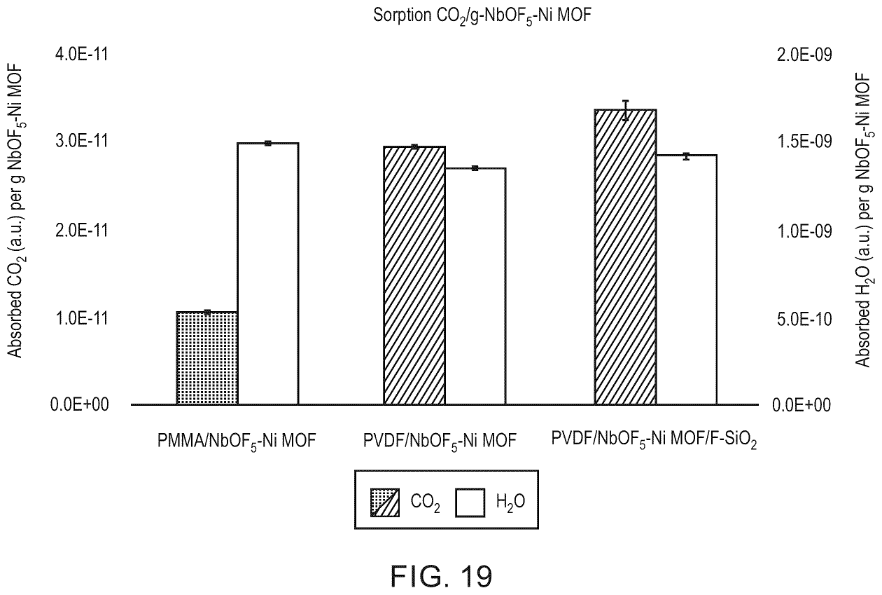

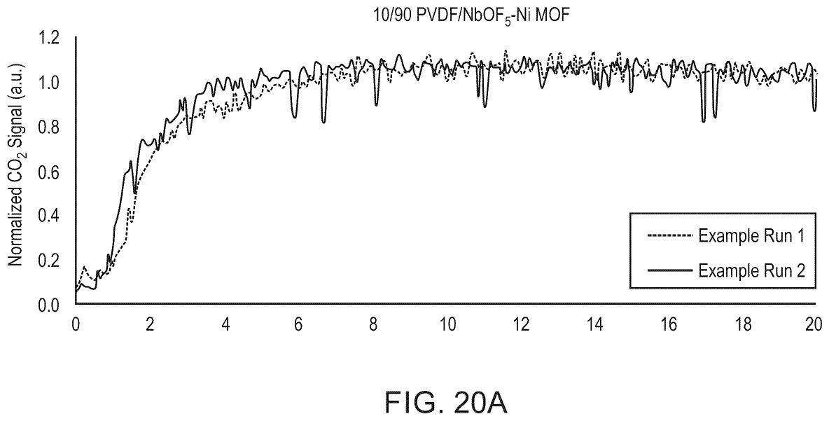

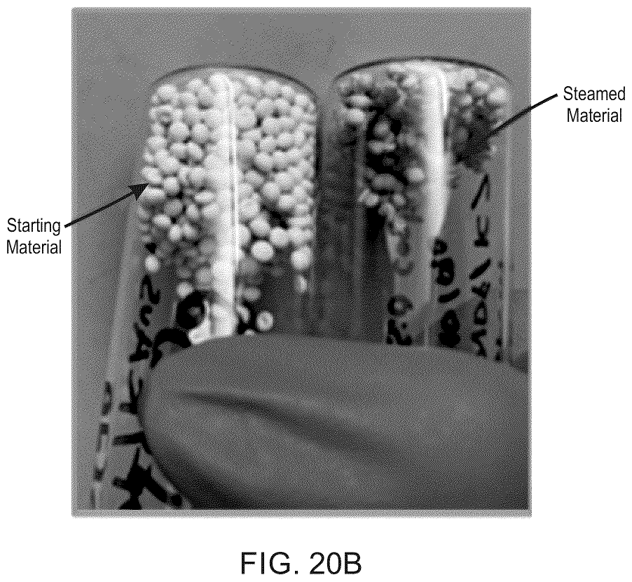

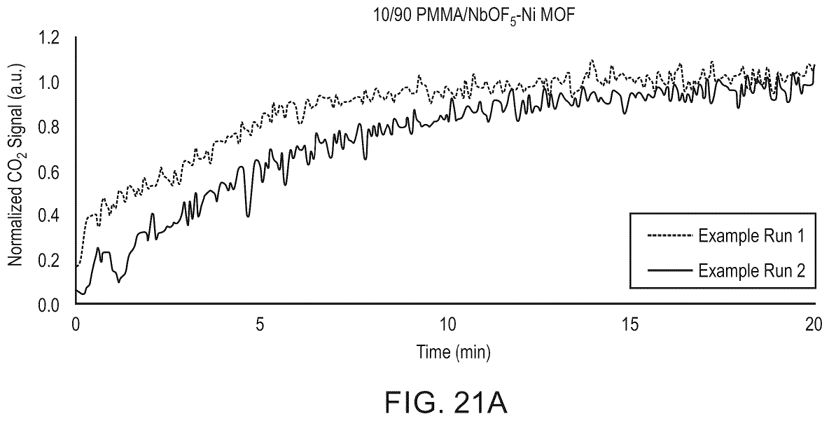

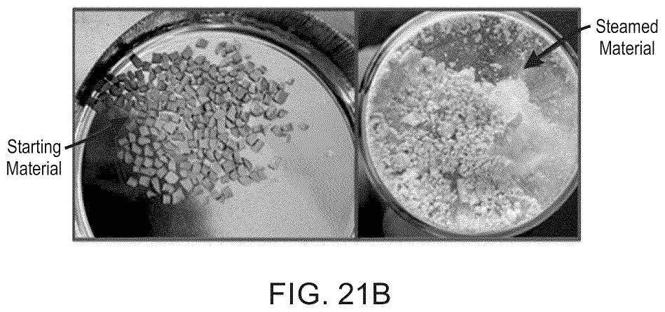

Adsorption column breakthrough experiments were also conducted on the structured sorbents to further evaluate their stability and CO₂—H₂O co-adsorption performance under the same testing conditions. Fixed-bed adsorption-desorption cycles were conducted at humid conditions (e.g., 30° C. and 50 mL/min flow of 20% relative humidity (RH) air containing 400 ppm of CO₂). An automatic gas adsorption instrument (AutoChem II Chemisorption Analyzer Micromeritics) was modified for breakthrough experiments by first packing approximately 1 gram of the shaped sorbent in the metal column and using glass beads on both ends of the column. The column was then activated at 110° C. with 40 mL/min N₂ gas flow for at least 30 minutes with the aid of heating tape. During the cycles, adsorption at ambient temperature (approximately 22° C.) and desorption steps were conducted for 10 minutes each. For adsorption, the feed air gas (50 mL/min) consisted of 400 ppm of CO₂ (20% relative humidity (RH) at 30° C.). In the desorption step, a pure water steam (approximately 5 mL/min) with a temperature of about 100 to about 125° C. was introduced to the bed. The steam is obtained from a steam generator during a CO₂ regeneration process. The CO₂ and H₂O concentrations of the outlet gas stream were continuously measured by a MKS Cirus 2 Mass Spectrometer. FIG. 19 shows a comparison of CO₂ and H₂O adsorption during an adsorption column breakthrough experiment under humid conditions. FIG. 20A shows example adsorption breakthrough curves for microporous PVDF/NbOF₅-Ni MOF/F-SiO₂ composite beads. FIG. 20B shows an example photograph of the starting material and steamed material (i.e., post adsorption study) of PVD/NbOF₅-Ni MOF beads. FIG. 21A shows example adsorption breakthrough curves for templated PMMA/NbOF₅-Ni MOF cubes. FIG. 21B shows an example photograph of the starting material and steamed material (i.e., post adsorption study) of PMMA/NbOF₅-Ni MOF cubes. These results indicate the improved hydrophobicity of the structured sorbents.

Further, the examples herein demonstrate that the shaping of NbOF₅-Ni MOF powders with hydrophobic polymer binders incorporating fluoro-functionalized silica inside the sorbent matrix presents a useful strategy towards the design of structured sorbents for effective CO₂ capture from humid air.

### EMBODIMENTS

1. A structured sorbent comprising:
a metal organic framework;
a hydrophobic binder; and
a hydrophobic carrier comprising fluorinated silica.

2. The structured sorbent of embodiment 1, wherein the metal organic framework comprises NbOF₅-Ni MOF.

3. The structured sorbent of embodiment 1 or 2, wherein the metal organic framework comprises 50-95 wt % of the structured sorbent.

4. The structured sorbent of any one of embodiments 1-3, wherein the hydrophobic binder comprises a hydrophobic polymer.

5. The structured sorbent of embodiment 4, wherein the hydrophobic polymer comprises polystyrene-block-polybutadiene-block-polystyrene (SBS), polyvinylidene difluoride (PVDF), polyacrylonitrile (PAN), or any combination thereof.

6. The structured sorbent of any one of embodiments 1-5, wherein the hydrophobic binder comprises 1-50 wt % of the structured sorbent.

7. The structured sorbent of any one of embodiments 1-6, wherein the fluorinated silica comprises tridecafluoro-derivatized silica gel, fluorochrome-derivatized silica gel, pentafluorophenyl-derivatized silica gel, perfluorocyclopentene functionalized silica, or trifluoropropylmethyl functionalized silica.

8. The structured sorbent of any one of embodiments 1-7, wherein the fluorinated silica comprises fluorinated silica particles, wherein the fluorinated silica particles are 5 μm to 60 μm in diameter.

9. The structured sorbent of any one of embodiment 1-8, wherein the fluorinated silica comprises 0.1-30 wt % of the structured sorbent.

10. The structured sorbent of any one of embodiments 1-9, wherein the metal organic framework comprises NbOF₅-Ni MOF and the hydrophobic binder comprises PVDF.

11. The structured sorbent of any one of embodiments 1-10, wherein the structured sorbent comprises 90 wt % NbOF₅-Ni MOF, 5 wt % PVDF, and 5 wt % fluorinated silica.

12. The structured sorbent of any one of embodiments 1-10, wherein the structured sorbent comprises 75 wt % NbOF₅-Ni MOF, 20 wt % PVDF, and 5 wt % fluorinated silica.

13. A method of making a structured sorbent, the method comprising:
preparing a binder solution, wherein the binder solution comprises a hydrophobic polymer and a first organic solvent;
preparing a hydrophobic carrier suspension, wherein the hydrophobic carrier suspension includes fluorinated silica and a second organic solvent;
mixing the binder solution and the hydrophobic carrier suspension to form a slurry;
adding a metal organic framework to the slurry to form a dope solution; and
adding the dope solution to a quench bath to precipitate the structured sorbent.

14. The method of embodiment 13, wherein adding the dope solution to the quench bath to precipitate the structured sorbent comprises adding the dope solution dropwise to the quench bath to precipitate the structured sorbent.

15. The method of embodiment 13 or 14, wherein the hydrophobic polymer comprises polystyrene-block-polybutadiene-block-polystyrene (SBS), polyvinylidene difluoride (PVDF), polyacrylonitrile (PAN), or any combination thereof.

16. The method of any one of embodiments 13-15, wherein the first organic solvent comprises dimethylformamide (DMF), N-methyl-2-pyrrolidone (NMP), dimethylacetamide (DMAc), triethyl phosphate (TEP), hexamethylphosphoramide (HMPA), or trimethylphosphate (TMP).

17. The method of any one of embodiments 13-16, wherein the binder solution comprises 5-50% hydrophobic polymer by weight.

18. The method of any one of embodiments 13-17, wherein the fluorinated silica comprises tridecafluoro-derivatized silica gel, fluorochrome-derivatized silica gel, pentafluorophenyl-derivatized silica gel, perfluorocyclopentene functionalized silica, or trifluoropropylmethyl functionalized silica.

19. The method of any one of embodiments 13-18, wherein the second organic solvent comprises polystyrene-block-polybutadiene-block-polystyrene (SBS), polyvinylidene difluoride (PVDF), polyacrylonitrile (PAN), or any combination thereof.

20. The method of any one of embodiments 13-19, wherein the hydrophobic carrier suspension comprises 0.1-30% fluorinated silica by weight.

21. The method of any one of embodiments 13-20, wherein the metal organic framework comprises NbOF₅-Ni MOF.

22. The method of any one of embodiments 13-21, wherein the structured sorbent comprises 50-95% NbOF₅-Ni MOF by weight.

23. A method of capturing CO₂, the method comprising:
contacting a structured sorbent with a CO₂ containing feed stream to yield a CO₂ depleted stream and a CO₂-loaded structured sorbent, wherein the structured sorbent comprises a metal organic framework, a hydrophobic binder, and a hydrophobic carrier, wherein the hydrophobic carrier comprises fluorinated silica;
hydraulically isolating the CO₂-loaded structured sorbent from the feed stream; and
recovering CO₂ from the CO₂-loaded structured sorbent to regenerate the structured sorbent.

24. The method of embodiment 23, wherein the metal organic framework comprises NbOF₅-Ni MOF.

25. The method of embodiment 23 or 24, wherein the hydrophobic binder comprises a hydrophobic polymer, wherein the hydrophobic polymer comprises polystyrene-block-polybutadiene-block-polystyrene (SBS), polyvinylidene difluoride (PVDF), polyacrylonitrile (PAN), or any combination thereof.

26. The method of any one of embodiments 23-25, wherein the fluorinated silica comprises tridecafluoro-derivatized silica gel, fluorochrome-derivatized silica gel, pentafluorophenyl-derivatized silica gel, perfluorocyclopentene functionalized silica, or trifluoropropylmethyl functionalized silica.

27. The method of any one of embodiments 23-26, wherein the feed stream is a flue gas.

28. The method of any one of embodiments 23-27, wherein the CO₂ depleted stream is released to the atmosphere.

29. The method of any one of embodiments 23-28, wherein recovering CO₂ from the CO₂-loaded structured sorbent to regenerate the structured sorbent comprises recovering CO₂ from the structured sorbent using temperature, steam, or a vacuum swing adsorption process.

30. The method of any one of embodiments 23-29, wherein the regenerated structured sorbent is re-exposed to the feed stream.

### Definitions

The term “about” as used in this disclosure can allow for a degree of variability in a value or range, for example, within 10%, within 5%, or within 1% of a stated value or of a stated limit of a range.

The term “solvent” as used in this disclosure refers to a liquid that can dissolve a solid, another liquid, or a gas to form a solution. Non-limiting examples of solvents are silicones, organic compounds, water, alcohols, ionic liquids, and supercritical fluids.

The term “room temperature” as used in this disclosure refers to a temperature of about 15 degrees Celsius (° C.) to about 28° C.

As used in this disclosure, “weight percent” (wt %) can be considered a mass fraction or a mass ratio of a substance to the total mixture or composition. Weight percent can be a weight-to-weight ratio or mass-to-mass ratio, unless indicated otherwise.

A number of implementations of the disclosure have been described. Nevertheless, it will be understood that various modifications may be made without departing from the spirit and scope of the disclosure.

What is claimed is:

1. A structured sorbent comprising:
a metal organic framework;
a hydrophobic binder; and
a hydrophobic carrier comprising fluorinated silica.

2. The structured sorbent of claim 1, wherein the metal organic framework comprises NbOF₅-Ni MOF.

3. The structured sorbent of claim 1, wherein the metal organic framework comprises 50-95 wt % of the structured sorbent.

4. The structured sorbent of claim 1, wherein the hydrophobic binder comprises a hydrophobic polymer.

5. The structured sorbent of claim 4, wherein the hydrophobic polymer comprises polystyrene-block-polybutadiene-block-polystyrene (SBS), polyvinylidene difluoride (PVDF), polyacrylonitrile (PAN), or any combination thereof.

6. The structured sorbent of claim 1, wherein the hydrophobic binder comprises 1-50 wt % of the structured sorbent.

7. The structured sorbent of claim 1, wherein the fluorinated silica comprises tridecafluoro-derivatized silica gel, fluorochrome-derivatized silica gel, pentafluorophenyl-derivatized silica gel, perfluorocyclopentene functionalized silica, or trifluoropropylmethyl functionalized silica.

8. The structured sorbent of claim 1, wherein the fluorinated silica comprises fluorinated silica particles, wherein the fluorinated silica particles are 5 μm to 60 μm in diameter.

9. The structured sorbent of claim 1, wherein the fluorinated silica comprises 0.1-30 wt % of the structured sorbent.

10. The structured sorbent of claim 1, wherein the metal organic framework comprises NbOF₅-Ni MOF and the hydrophobic binder comprises PVDF.

11. The structured sorbent of claim 10, wherein the structured sorbent comprises 90 wt % NbOF₅-Ni MOF, 5 wt % PVDF, and 5 wt % fluorinated silica.

12. The structured sorbent of claim 10, wherein the structured sorbent comprises 75 wt % NbOF₅-Ni MOF, 20 wt % PVDF, and 5 wt % fluorinated silica.

13. A method of making a structured sorbent, the method comprising:
preparing a binder solution, wherein the binder solution comprises a hydrophobic polymer and a first organic solvent;
preparing a hydrophobic carrier suspension, wherein the hydrophobic carrier suspension includes fluorinated silica and a second organic solvent;
mixing the binder solution and the hydrophobic carrier suspension to form a slurry;
adding a metal organic framework to the slurry to form a dope solution; and
adding the dope solution to a quench bath to precipitate the structured sorbent.

14. The method of claim 13, wherein adding the dope solution to the quench bath to precipitate the structured sorbent comprises adding the dope solution dropwise to the quench bath to precipitate the structured sorbent.

15. The method of claim 13, wherein the hydrophobic polymer comprises polystyrene-block-polybutadiene-block-polystyrene (SBS), polyvinylidene difluoride (PVDF), polyacrylonitrile (PAN), or any combination thereof.

16. The method of claim 13, wherein the first organic solvent comprises dimethylformamide (DMF), N-methyl-2-pyrrolidone (NMP), dimethylacetamide (DMAc), triethyl phosphate (TEP), hexamethylphosphoramide (HMPA), or trimethylphosphate (TMP).

17. The method of claim 13, wherein the binder solution comprises 5-50% hydrophobic polymer by weight.

18. The method of claim 13, wherein the fluorinated silica comprises tridecafluoro-derivatized silica gel, fluorochrome-derivatized silica gel, pentafluorophenyl-derivatized silica gel, perfluorocyclopentene functionalized silica, or trifluoropropylmethyl functionalized silica.

19. The method of claim 13, wherein the second organic solvent comprises polystyrene-block-polybutadiene-block-polystyrene (SBS), polyvinylidene difluoride (PVDF), polyacrylonitrile (PAN), or any combination thereof.

20. The method of claim 13, wherein the hydrophobic carrier suspension comprises 0.1-30% fluorinated silica by weight.

21. The method of claim 13, wherein the metal organic framework comprises NbOF₅-Ni MOF.

22. The method of claim 13, wherein the structured sorbent comprises 50-95% NbOF₅-Ni MOF by weight.

23. A method of capturing CO₂, the method comprising:
contacting a structured sorbent with a CO₂ containing feed stream to yield a CO₂ depleted stream and a CO₂-loaded structured sorbent, wherein the structured sorbent comprises a metal organic framework, a hydrophobic binder, and a hydrophobic carrier, wherein the hydrophobic carrier comprises fluorinated silica;
hydraulically isolating the CO₂-loaded structured sorbent from the feed stream; and
recovering CO₂ from the CO₂-loaded structured sorbent to regenerate the structured sorbent.

24. The method of claim 23, wherein the metal organic framework comprises NbOF₅-Ni MOF.

25. The method of claim 23, wherein the hydrophobic binder comprises a hydrophobic polymer, wherein the hydrophobic polymer comprises polystyrene-block-polybutadiene-block-polystyrene (SBS), polyvinylidene difluoride (PVDF), polyacrylonitrile (PAN), or any combination thereof.

26. The method of claim 23, wherein the fluorinated silica comprises tridecafluoro-derivatized silica gel, fluorochrome-derivatized silica gel, pentafluorophenyl-derivatized silica gel, perfluorocyclopentene functionalized silica, or trifluoropropylmethyl functionalized silica.

27. The method of claim 23, wherein the feed stream is a flue gas.

28. The method of claim 23, wherein the CO₂ depleted stream is released to the atmosphere.

29. The method of claim 23, wherein recovering CO₂ from the CO₂-loaded structured sorbent to regenerate the structured sorbent comprises recovering CO₂ from the structured sorbent using temperature, steam, or a vacuum swing adsorption process.

30. The method of claim 23, wherein the regenerated structured sorbent is re-exposed to the feed stream.
